(19) United States
(12) Patent Application Publication
(10) Pub. No.: US 2016/0166057 A1
(43) Pub. Date: Jun. 16, 2016

(54) Adaptable Multi-fold Workstation

(71) Applicant: Storage Designs LLC, Alpine, UT (US)

(72) Inventors: Wayne Hubert, Alpine, UT (US); Garth Hubert, Provo, UT (US)

(73) Assignee: Storage Designs LLC, Alpine, UT (US)

(21) Appl. No.: 14/568,867

(22) Filed: Dec. 12, 2014

(51) Int. Cl. A47B 43/00; A47B 39/04; A47B 5/04; A47B 96/18; A47B 91/00; B60B 33/00; A47B 37/00; A47B 46/00

(52) U.S. Cl. CPC A47B 43/00; A47B 37/00; A47B 39/04; A47B 46/005; A47B 96/18; A47B 91/00; B60B 33/0002; A47B 5/04; A47B 2200/09; A47B 2220/0002

(57) ABSTRACT

A compact workstation includes a base workstation compartment that includes a floor, a plurality of side walls, a top member, and a back member. Each of the side walls are joined to the floor, back member, and top member and form a first cavity with a first depth. At least one multi-fold door is rotatably coupled to each of the side walls. At least of the one multi-fold doors includes a secondary compartment and a tertiary compartment. A base underside of the base workstation compartment is supported by at least a first wheel and a second wheel, the secondary compartments are supported by at least a third wheel and a fourth wheel, and the tertiary compartments are supported by at least a fifth wheel and a sixth wheel.

### BACKGROUND

Many homeowners have customized their garages or sheds to store tools and work on projects. Such customizations often include a work table and tool storage. However, making such customization can cost thousands of dollars and be very time consuming.

The following design patents illustrate ornamental designs of various desks. U.S. Des. Pat. No. 376,491, issued to James O. Kelley on Dec. 17, 1996, illustrates a computer secretary. The ornamental design includes two separate compartments enclosed by four doors. The compartments include shelves, drawers, and a work surface, but does not include a bifolding door. U.S. Des. Pat. No. 376,496, issued to Kelly, et al. on Dec. 17, 1996, illustrates a computer workplace having one major compartment enclosed by two doors, not bi-fold doors.

The following patents disclose various types of desks and work stations. U.S. Pat. No. 1,099,521, issued to Abbe Sprung on Jun. 9, 1914, describes an office desk including a pigeon hole rack in which letters or papers may be quickly filed. It has an ordinary flat top desk which may raise the pigeon hole rack by a trip element actuated by the operator.

U.S. Pat. No. 5,121,974, issued to Alan R. Monson on Jun. 16, 1992, describes a computer desk apparatus with parallel walls formed with a front wall defining a central cavity. The central cavity is positioned between a right series of storage drawers and a left storage door positioned hingedly in front of a printer cavity which further includes a medially positioned slide-out drawer. Extending upwardly from a lower desk plate are right and left storage shelves. The upper cavity includes a roll-top member directed over the cavity to provide protection for the organization when not in use.

U.S. Pat. No. 5,590,940, issued to Michael B. Richard on Jan. 7, 1997, describes a sliding rack cabinet for dressers. The cabinet includes a rectilinearly shaped cabinet member having a peripheral edge wall. The back wall is connected to and spanning the peripheral edge wall. A tie is rack mounted to the peripheral edge wall adjacent to the top edge wall.

U.S. Pat. No. 5,695,264, issued to David T. Koch on Dec. 9, 1997, describes a portable office unit with an enclosure that includes two hingedly connected shells. U.S. Pat. No. 5,738,422, issued to Welborn, Jr. et al. on Apr. 14, 1998, describes a computer work station which includes a first desk unit with a front tapered edge. The first desk unit has an electrical control panel with surge protected outlets. The work station has a second desk unit, one end of the second desktop being inserted into and supported by a support rail in a bookcase and the other end being placed upon and secured to a file cabinet.

U.S. Pat. No. 5,842,758, issued to James O. Kelley on Dec. 1, 1998, describes a sky cabinet work station having a pair of opposing side panels which have vertically oriented elongated members. The top includes a transparent or translucent panel which is adapted to transmit light through the panel to illuminate the work station.

U.S. Pat. No. 5,678,905, issued to James O. Kelley on Oct. 21, 1997, and U.S. Pat. No. 5,927,833, issued to James O. Kelley on Jul. 27, 1999, both describes a concealed desk which comprises a desktop or work surface with supporting side panels, a kneehole opening, and storage compartments. The front of the desk is enclosable by folding doors mounted on front side edges of the desk's side panels.

When the doors are opened, the doors preferably fold against the side panels of the desk and do not obstruct either the appearance or the use of the desk. The desktop surface of the desk is concealed by an upper storage unit that is mounted on the desktop or that comprises an extension of the desk, above the desktop or work surface. Full lengths doors enclose both the upper and lower portions of the desk to give the furniture the appearance of an armoire. French Pat. No. 2,650,494, published Feb. 8, 1991, describes a work place for a computer having lower shelving and storage units.

### SUMMARY

In one aspect of the invention, a compact workstation includes a base workstation compartment that includes a floor, a plurality of side walls, a top member, and a back member. Each of the side walls are joined to the floor, back member, and top member and form a first cavity with a first depth. At least one multi-fold door is rotatably coupled to each of the side walls. At least of the one multi-fold doors includes a secondary compartment and a tertiary compartment. The secondary compartment is rotatably coupled on a first side to the side walls of the base workstation compartment, and the secondary compartment has a second cavity with a second depth. The tertiary compartment is rotatably coupled to a second side of the secondary compartment, and the tertiary compartment forms a third cavity with a third depth. A base underside of the base workstation compartment is supported by at least a first wheel and a second wheel, the secondary compartments are supported by at least a third wheel and a fourth wheel, and the tertiary compartments are supported by at least a fifth wheel and a sixth wheel.

In some examples, the side walls of the base workstation compartment include an interior height that spans from the floor to the top member and the tertiary compartments each comprise an exterior height that is less than the interior height of the base workstation compartment. The exterior height of the tertiary compartments may be greater than 90.0 percent of the interior height of the base workstation compartment. A vertical position of the tertiary compartments and the exterior height of the tertiary compartments may allow the tertiary compartments to reside within the first cavity of the base workstation compartment when the secondary compartments and the tertiary compartments are in closed positions.

Further, the fifth and sixth wheels may be disposed along a width of the tertiary compartments. Also, the third and fourth wheels may be positioned adjacent to hinges that connect the secondary compartments to the tertiary compartments. Additionally, a seventh wheel and an eighth wheel may support the secondary compartments where the seventh wheel and the eighth wheel are disposed along a width of the secondary compartments. In some cases, the floor of the base workstation compartment has a cutout that accommodates the fifth wheel and sixth wheel when the secondary compartment and the tertiary compartments are in a closed position.

In some cases, the multi-fold door is a bi-fold door. Also, the second depth of the secondary compartment may be less than the first depth of the base workstation compartment. Similarly, the third depth of the tertiary compartment may be less than the second depth of the secondary compartment.

At least one of the secondary compartments may include an exterior lock that is configured to lock into an internal portion of the base workstation compartment when at least one of the secondary compartments is in a closed position. The workstation may also include a collapsible table rotatably coupled to the base workstation compartment where the collapsible table is configured to be rotated from a vertical position to a horizontal position. At least one of the base workstation compartment, the secondary compartments, and the tertiary compartments may have shelving brackets to receive at least one shelf. Also, at least one of the tertiary compartments may have a perforated hardboard.

In another aspect of the invention, a compact workstation includes a base workstation compartment that has a floor, a plurality of side walls, a top member, and a back member. Each of the side members is joined to the floor, back member, and top member forming a first cavity with a first depth. At least one multi-fold door is rotatably coupled to each of the side walls where at least one of the multi-fold doors includes a secondary compartment and a tertiary compartment. The secondary compartment is rotatably coupled on a first side to the side walls of the base workstation compartment, and the secondary compartment has a second cavity with a second depth that is less than the first depth. The tertiary compartment is rotatably coupled to a second side of the secondary compartment, and the tertiary compartment forms a third compartment with a third depth that is less than the second depth. A base underside of the base workstation compartment is supported by at least a first wheel and a second wheel, and the secondary compartment is supported by at least a third wheel and a fourth wheel where the fifth and sixth wheels are disposed along a width of the tertiary compartments. The tertiary compartments are supported by at least a fifth wheel and a sixth wheel. The third and fourth wheels are positioned adjacent to hinges that connect the secondary compartments to the tertiary compartments. At least a seventh wheel and an eighth wheel support the secondary compartments where the seventh wheel and the eighth wheel are diposed along a width of the secondary compartments.

In yet another aspect of the invention, a compact workstation has a base workstation compartment that includes a floor, a plurality of side walls, a top member, and a back member. Each of the side members is joined to the floor, back member, and top member forming a first cavity with a first depth. At least one multi-fold door is rotatably coupled to each of the side walls where at least one of the multi-fold doors includes a secondary compartment and a tertiary compartment. The secondary compartment is rotatably coupled on a first side to the side walls of the base workstation compartment, and the secondary compartment has a second cavity with a second depth that is less than the first depth. The tertiary compartment is rotatably coupled to a second side of the secondary compartment, and the tertiary compartment forms a third compartment with a third depth that is less than the second depth. The side walls of the base workstation compartment include an interior height that spans from the floor to the top member, and the tertiary compartments each comprise an exterior height that is less than the interior height of the base workstation compartment. The exterior height of the tertiary compartments is greater than 90.0 percent of the interior height of the base workstation compartment. A vertical position of the tertiary compartments and the exterior height of the tertiary compartments allows the tertiary compartments to reside within the first cavity of the base workstation compartment when the secondary compartments and the tertiary compartments are in closed positions. A base underside of the base workstation compartment is supported by at least a first wheel and a second wheel, and the secondary compartments are supported by at least a third wheel and a fourth wheel. The tertiary compartments are supported by at least a fifth wheel and a sixth wheel. The third and fourth wheels are positioned adjacent to hinges that connect the secondary compartments to the tertiary compartments. The fifth and sixth wheels are centered along a width of the tertiary compartments. At least a seventh wheel and an eighth wheel support the secondary compartments where the seventh wheel and the eighth wheel are centered along a width of the secondary compartments. The floor of the base workstation compartment comprises a cutout that accommodates the fifth wheel and sixth wheel when the secondary compartment and the tertiary compartment are in a closed position. At least one of the secondary compartments includes an exterior lock that is configured to lock into an internal portion of the base workstation compartment when the secondary compartment is in a closed position. A collapsible table is rotatably coupled to the base workstation compartment where the collapsible table is configured to be rotated from a vertical position to a horizontal position. At least one of the base workstation compartment, the secondary compartments, and the tertiary compartments have shelving brackets to receive at least one shelf, and at least one of the tertiary compartments has a perforated hardboard.

Any of the aspects of the principles detailed above may be combined with any of the other aspect detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 is a perspective view of an example of a workstation in a closed position according to the present disclosure.

FIG. 2 is a perspective view of an example of a workstation in an open position according to the present disclosure.

FIG. 3 is a front view of an example of a workstation in an open position according to the present disclosure.

FIG. 4 is a bottom view of an example of a workstation in an open position according to the present disclosure.

FIG. 5 is a perspective view of an example of a workstation in an open position according to the present disclosure.

Throughout the drawings, identical reference numbers designate similar, but not necessarily identical, elements.

### DETAILED DESCRIPTION

The present specification describes a compact workstation constructed to meet the storage, accessibility, aesthetics, and work space specifications desired for a variety of tasks. For example, the compact workstation may be used for scrapbooking, woodworking, repairing electronics or other devices, building, gun maintenance, fly tying, other activities, or combinations thereof. While the workstation may be used to efficiently store any number of materials for any number of purposes including storing and working with tools, and the like, for ease of explanation only, the workstation will be described in the context of a compact workstation that stores tools, such as hammers, saws, screwdrivers, nails, screws, nuts, bolts, clips, clamps, other types of fasteners, levels, scrapers, painting supplies, grinders, welders, voltmeters, measuring tapes, drills, wrenches, routers, chalking supplies, spare parts, air compressors, safety glasses, fishing gear, guns, hunting gear, cleaning supplies, knives, wires, wire cutters, wire strippers, outdoor tools, trimmers, hoses, rope, camping gear, staples, staplers, drill bits, sanders, extension cords, chain saws, lights, plumbing tools, work gloves, Allen wrenches, straps, pumps, jackstands, step stools, ladders, PVC pipe, pipe, pipe cutters, socket wrenchs, pliers, tool sets, scrub brushes, tie wire, stud finders, bungee cords, flash lights, cleaning chemicals, duct tape, shovels, scrap wood, sprayer, other tools, other supplies, or combinations thereof.

As mentioned previously, there have been developed a number of traditional desks and workstations. However, normal sized shelves and drawers cannot accommodate the various large sizes of tools, spare parts, devices, and so forth. Additionally, due to the high quantity of small items, such as fasteners, washers, pencils, and other smaller elements often associated with construction or repair jobs, the number of available storage locations in traditional workstations are not sufficient. An ideal work surface would include a large sized work surface with drawers specifically constructed to hold various sized tools with various types of shapes.

According to the principles described herein, the workstation includes a number of advantageous features including, but in no way limited to, a plurality of multi-fold doors for maximizing storage space when open and minimizing storage space when not in use. Such a workstation may include adjustable shelves, clips for removable bins, perforated hardboards, and the like. Further details of the workstation will be provided below with reference to the Figures.

In the following description, for purposes of explanation, numerous specific details are set forth to provide a thorough understanding of the workstation. It will be apparent, however, to one skilled in the art that the present workstation may be practiced without these specific details. Reference in the specification to “one example” or “an example” means that a particular feature, structure, or characteristic described in connection with the example is included in at least one example of the workstation. The appearance of the phrase “in one example” in various places in the specification are not necessarily all referring to the same embodiment of the workstation.

As mentioned, FIGS. 1-4 illustrate various views of the workstation 100 according to one example. As illustrated in FIG. 1, the workstation 100 have the form of an armoire. The workstation 100 may be made of any appropriate type of material including, but not limited to, metal, wood, plastic, composites, other types of material, or combinations thereof.

When closed, the workstation 100 includes a pair of multi-fold door set 102 with a first door 104 and a second door 106. In some examples, at least one of the doors 104, 106 is equipped with handles. Further, any appropriate type of decorations may be included on the exterior of the workstation 100. For example, the exterior of the workstation may include a facade that provides an aesthetic look. Such a look may be provided by any number of materials including, but in no way limited to, wood, plastic, metal, composites, posters, and/or combinations thereof.

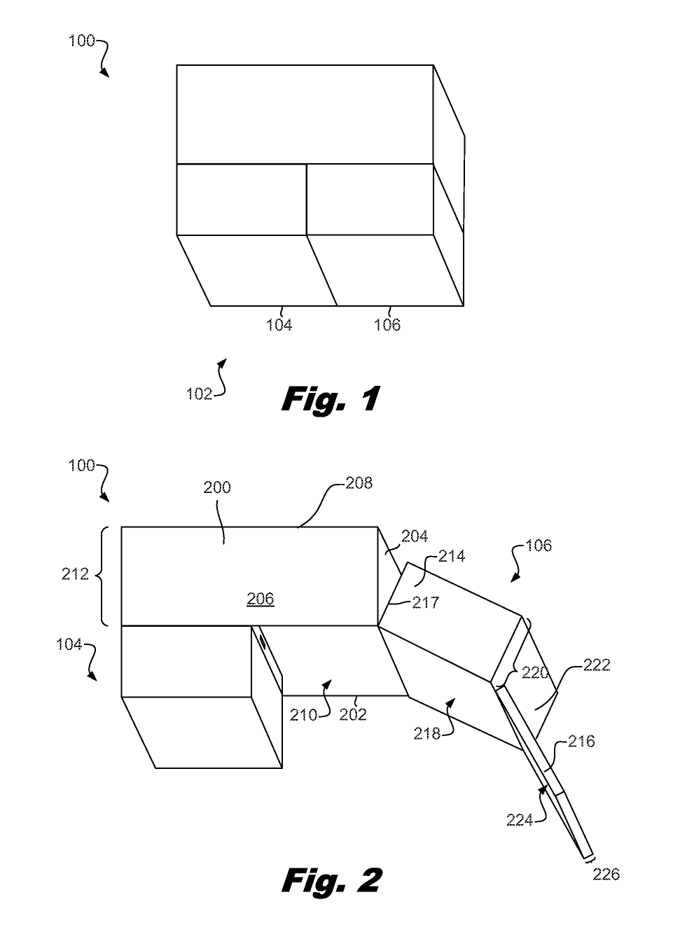

As demonstrated in FIG. 2, the multi-fold doors 104, 106 may be opened to provide access to the storage capacity of the workstation 100. The workstation 100 may include a base workstation compartment 200 that includes a floor 202, a plurality of side walls 204, a top member 206, and a back member 208. Each of the side walls 204 being joined to the floor 202, back member 208, and top member 206 forming a first cavity 210 with a first depth 212. Each of the doors 104, 106 may be rotatably coupled to each of the side walls 204.

At least one multi-fold door 104, 106 may include a secondary compartment 214 and a tertiary compartment 216. The secondary compartment 214 is rotatably coupled on a first side 217 to the side walls 204 of the base workstation compartment 200. In some examples, the secondary compartment 214 is coupled to the base workstation compartment 200 though a continuous hinge, a plurality of discrete hinges, other types of connectors, or combinations thereof. The secondary compartment may include a second cavity 218 with a second depth 220 that is less than the first depth 212.

The tertiary compartment 216 may also be rotatably coupled to a second side 222 of the secondary compartment 214. Likewise, the tertiary compartment 216 may be coupled to the secondary compartment 214 though a continuous hinge, a plurality of discrete hinges, other types of connectors, or combinations thereof. The tertiary compartment 216 may form a third cavity 224 with a third depth 226 that is less than the second depth 220.

When the workstation is in the open position, each of the first cavity 210, the second cavities 218, and the third cavities 224 are accessible to a user from a single side of the workstation 100. To close the workstation, the tertiary compartments 216 are folded into the secondary compartments 214. Then, the multi-fold doors, which collectively include the secondary compartment 214 and tertiary compartment 216, are rotated towards the first cavity 210 of the base workstation compartment 200. The tertiary compartment 216 may include a tertiary height that is less than the first height of the base workstation compartment 200. As such, when the multi-fold doors 104, 106 are closed, the tertiary compartment 216 may enter and reside within the first cavity 210 of the base workstation compartment 200. The secondary height of the secondary compartment 214 may be the same as the first height of the base workstation compartment 200. As such, when the tertiary compartment 216 is brought together with the secondary compartment 214, a step is formed in the multi-fold doors' top surface. However, with the tertiary compartment 216 within the first cavity 210, the step is obscured from view. In the illustrated example, the top surface of the secondary compartment 214 and the top surface of the base workstation compartment 200 are flush with each other when the workstation 100 is closed. Thus, from the outside, the workstation 100 may appear to have just the base workstation compartment 200 and the secondary compartments 214.

With the base workstation compartment 200, the secondary compartments 214, and the tertiary 216 in the arrangement as described above, the workstation 100 can occupy a small space when the workstation 100 is in the closed position. However, when open, the workstation 100 makes accessible all of the compartments 200, 214, 216 in an expanded space that makes a large amount of storage space accessible to the user from a single side of the workstation 100.

In alternative examples, at least one of the multi-doors includes a quaternary compartment, a quinary compartment, a senary compartment, another type of compartment, or combinations thereof. Such additional compartments may sequentially fold in with the secondary and tertiary compartments 214, 216 or fold in different directions than the secondary and tertiary compartments 214, 216.

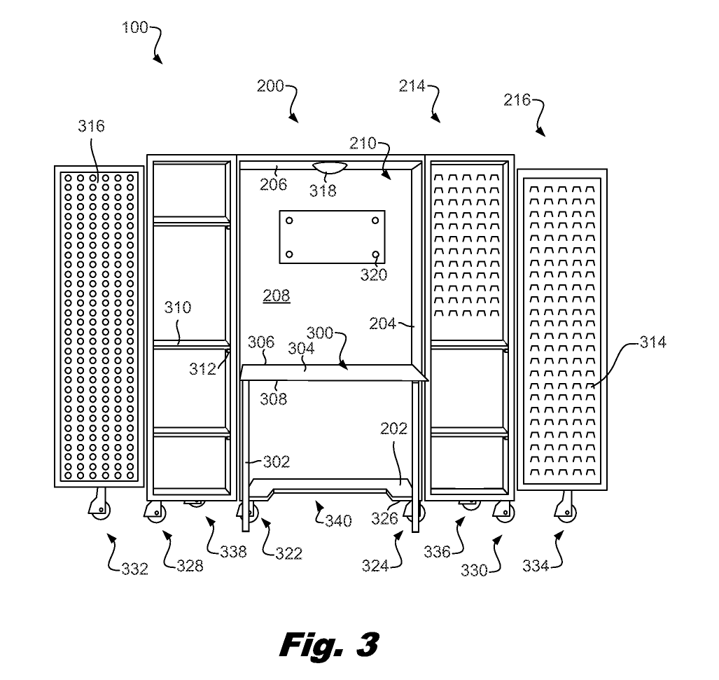

Turning now to FIG. 3, the opening of the multi-fold doors 104, 106 allows for the engagement of a folding table 300 disposed within the first cavity 210 of the base workstation compartment 200. As shown, the folding table 300 includes a plurality of collapsible hinged legs 302 that may be folded substantially parallel with the working surface 304 of the table 300 when stored. Additionally, a back edge 306 of the working surface 304 is hinged to the back member 208 of the base workstation compartment 200 such that the working surface 304 of the table 300 may be pivotably rotated in and out of position within the base workstation compartment 200. According to one example of the workstation, when the multi-fold doors 104, 106 are opened to grant access to the first cavity 210, the front edge 308 of the folding table 300 may be grasped and pulled upward, allowing the collapsible hinged legs 302 to open and support the working surface 304. Once opened, the working surface 304 will be supported by both the collapsible legs 302 and the back edge 306 of the working surface 304 coupled to the base workstation compartment's back member 208.

As mentioned previously, the workstation 100 may include a number of adjustable shelves 310. Each adjustable shelf 310 may be secured to brackets 312 that are connected to back members of any of the compartments. For example, in FIG. 3, brackets 312 for the adjustable shelves 310 are depicted in the secondary compartments 214. However, in other examples, such brackets 312 may be secured within the tertiary compartments 216 and/or the base workstation compartment 200. In some examples, just one of the two secondary compartments 214 have brackets 312 for the adjustable shelves 310.

The adjustable shelves 310 may be positioned according to the type of object that is desired to be stored on the shelves. For example, a tool or other object that has a height of two feet while resting on a shelf may dictate that a space between shelves 310 be at least two feet to accommodate that object. However, other objects with shorter heights may allow other shelves 310 to be spaced closer together. Additionally, the width of the object may also dictate whether the adjustable shelf for that object is secured within the secondary compartment 214, the tertiary compartment 216, or the base workstation compartment 200. For example, the secondary compartment 214 has a greater depth than the tertiary compartment 216. Thus, a user may select the secondary compartment 214 to store objects that can benefit from the compartment's greater depth.

In addition to the adjustable shelves 310, the detachable bins may be secured to hooks 314 incorporated into the back members of any of the compartments. In the example of FIG. 3, the hooks 314 are depicted as being secured to just one of the tertiary compartments 216. The bins may be sized based on the desired objects to be stored within the bins. For example, a small bin may be selected to be secured with the hooks 314 for small objects such as specific types of nails, screws, other types of fasteners, washers, other objects, or combinations thereof. Such small bins may utilize a single hook when being secured to the back members. In other examples, larger bins to store larger objects, may use multiple hooks 314, such as multiple hooks 314 on a single row, when being secured to the back member.

Further, a perforated hardboard 316 may be incorporated into any of the compartments. The perforated hardboard 316 may be secured to the back member of the selected compartment. Preformed holes, such as pre-drilled holes, may be spaced throughout the perforated hardboard 316. The holes may be used to accept pegs or hooks that can be used to support various items, such an hammers, wrenches, other types of tools, other types of supplies, or combinations thereof. The perforated hardboard 316 may be made of any appropriate type of material, such as metal, plastic, wood, composites, other types of materials, or combinations thereof.

While this example has been described with reference to the adjustable shelves 310, brackets 312, bin hooks 314, and perforated hardboard 316 being located in specific compartments of the workstation, each of the adjustable shelves 310, brackets 312, bin hooks 314, and perforated hardboard 316 may be located collectively or individually with the different compartments of the workstation 100. In some examples, all of the compartments include the perforated hardboard 316 while in other examples just a subset of the compartments includes the perforated hardboard 316. In yet other examples, none of the compartments include the perforated hardboard 316. Likewise, all of the compartments include the adjustable shelves 312 while in other examples just a subset of the compartments includes the adjustable shelves 312. In yet other examples, none of the compartments include the bin hooks 314. Similarly, all of the compartments include the bin hooks 314 while in other examples just a subset of the compartments includes the bin hooks 314. In yet other examples, none of the compartments include the bin hooks 314. While the examples above have been described with reference to specific types of mechanism for storing tools and supplies in the various compartments of the workstation (e.g. the shelves 312, hooks 314, and perforated hardboard 316), other types of mechanisms for storing tools and/or supplies in the compartments of the workstation 100 may be used in accordance with the principles described in the present disclosure.

In some cases, the workstation 100 may also include a power strip (not shown) integrally wired into the workstation 100. In some examples, a surge protected power strip may provide a convenient location for a person using the workstation 100 to plug-in electronic devices including, but in no way limited to, grinders, power tools, saws, welders, computers, printers, radios, televisions, and the like.

In some examples, a light fixture 318 is incorporated into the top member 206 of the base workstation compartment 200. In such examples, the light fixture 318 may be positioned over the folding table 300 to provide light to the user utilizing the table 300 during his or her project.

In another example, the back member 208 of the base workstation compartment 200 includes at least one opening 320 to receive a screw or another type of fastener for securing the workstation 100 to a wall. Such fasteners may prevent against theft.

In addition to the above-mentioned capabilities, the workstation 100 may include a number of wheels coupled to the bottom members of the compartments. The wheels may support the workstation 100 and allow for the workstation 100 to be movable as desired by the user. Consequently, the workstation 100 may be stored in a small out of the way location in a user's home and may then be wheeled to a convenient location for use.

In the illustrated example, a first wheel 322 and a second wheel 324 are attached to an underside 326 of the floor 202 of the base workstation compartment 200. Further, a third wheel 328 is attached to one of the secondary compartments 214 and a fourth wheel 330 is attached to the other of the secondary compartments 214. Also, a fifth wheel 332 is attached to one of the tertiary compartments 216, and a sixth wheel 334 is attached to the other tertiary compartment 216. Additional wheels may be attached to any of the compartments. For instance, in the example of FIG. 3 a seventh wheel 336 and an eighth wheel 338 is attached to the secondary compartments 214.

In some examples, the fifth and sixth wheels 332, 334 are disposed along a width of the tertiary compartments 216. In some examples, the fifth and sixth wheels 332, 334 are centered along the width of the tertiary compartments 216. By being placed in the center of the tertiary compartments 216, the weight of the tertiary compartment 216 and all of the items being held in the tertiary compartments 216 may be directed toward the fifth and sixth wheels 332, 334 when the workstation is opened.

The third and fourth wheels 328, 330 may be positioned adjacent to hinges that connect the secondary compartments to the tertiary compartments 216. By being positioned adjacent the rotary connection, the third and fourth wheels 328, 330 can take up the outside load when the multi-fold doors are open, but the tertiary compartments 216 are folded inward towards the secondary compartments 214.

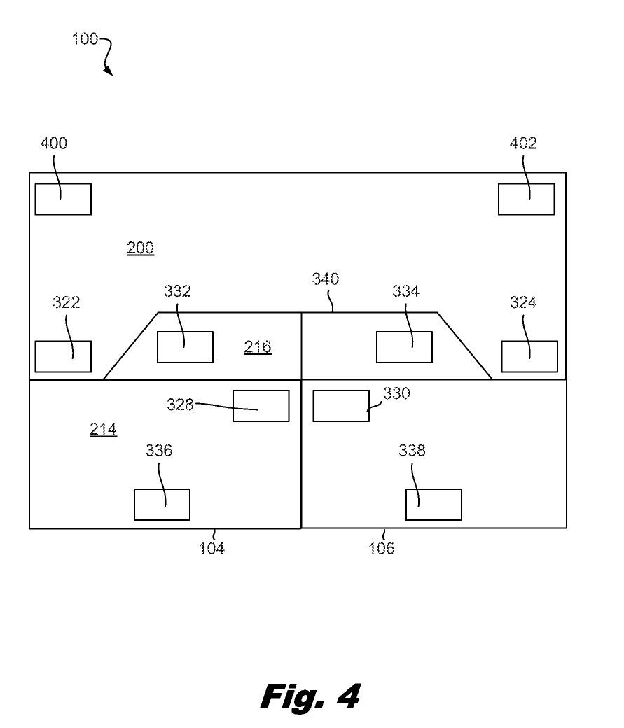

The seventh and eighth wheels 336, 338 may disposed along a width of the secondary compartments 216. In some examples, the seventh and eighth wheels 336, 338 are centered along a width of the secondary compartments 216. In this manner, when the workstation 100 is closed such that the multi-fold doors are folded inward, the seventh and eighth wheels 336, 338 may pick up the front load when the workstation 100 is closed as is depicted in FIG. 4.

The floor 202 of the base workstation compartment 200 comprises a cutout 340 that accommodates the fifth wheel 332 and sixth wheel 334 when the secondary compartments 216 and the tertiary compartments 216 are in a closed position. In some examples where the height of the tertiary compartments 216 is less than the height of the base workstation compartment 200, the underside of the tertiary compartment 216 may rest on the floor 202 of the base workstation compartment 200. In such an example, the load of the tertiary compartments 216 is distributed to the wheels that support the underside of the base workstation compartment 200. In some examples, a gap exists between the underside of the tertiary compartments 216 and the floor 202 of the base workstation compartment 200. However, in some examples, the gap is predetermined to be such that when tertiary compartment is weighted down with a predetermined load, that the gap will be eliminated so that the weight loaded to the tertiary compartment 216 is distributed to the floor 202 and the wheels that support the base workstation compartment 200.

FIG. 4 depicts an underside of the workstation 100 depicted in FIG. 3 except that the workstation is in the closed position. In this example, the first and second wheels 322, 324 are depicted as being attached to the base workstation compartment 200 with a ninth wheel 400 and a tenth wheel 402 that were hidden from view in FIG. 3. The first, second, ninth, and tenth wheels 322, 324, 400, 402 support the base workstation compartment 200 in both the open and closed positions. The third, fourth, seventh and eighth wheels 330, 322, 336, 338 support the secondary compartments 214 when the workstation is open and closed. However, the secondary compartments' center of weight may shift between the open and closed positions. For example, in the closed position, the face of the secondary compartments 214 may be in contact with the face of the base workstation compartment 200 thereby transferring at least some of the secondary compartment's weight to the base workstation compartment 200 thereby taking some of the load off of the third and fourth wheels 330, 332. Also, the seventh and eighth wheels 336, 338 may pick up an additional load as these wheels are now the front of the workstation 100. Also, some of the load on the fifth and sixth wheels 332, 334, which supports the tertiary compartments 216 may be loaded to the floor 202 of the base workstation compartment 200. In such an example, part of the load of the tertiary compartment 216 may be loaded to the first and second wheels 322, 324. In the example of FIG. 4, the fifth and sixth wheels 332, 334 are disposed within the cutout 340 of the base workstation compartment's floor 202.

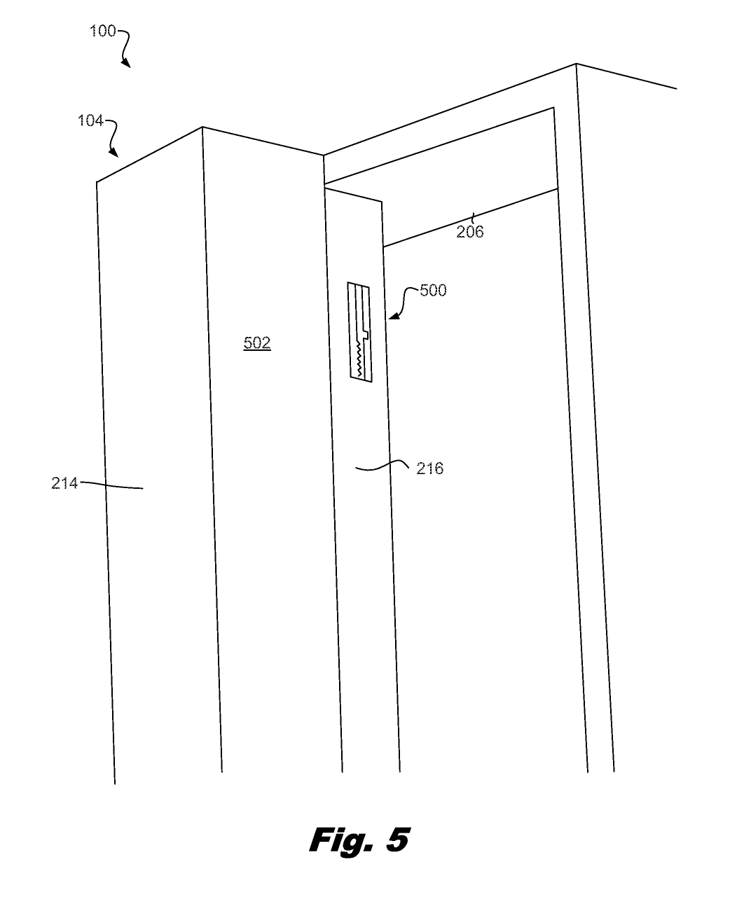

FIG. 5 depicts an example where one of the multi-fold doors is closed. In this example, the tertiary compartment 216 resides within the first cavity 210 of the base workstation compartment 200. The tertiary compartment 216 may have a height that is shorter than the height of the base workstation compartment 200 allowing the tertiary compartment's top to slide past the top member 206 of the base workstation compartment 200 and the tertiary compartment's bottom to slide past the floor 202 of the base workstation compartment 200. Thus, the tertiary compartment 200 may be nested within the first cavity 210 of the base workstation compartment 200.

In such an example, the tops of the secondary compartment 214 and the base workstation compartment 200 can be flush. Further, the hinge or another rotary coupling joining the secondary compartment 214 and the tertiary compartment 216 is concealed within the workstation 100 when the workstation 100 is closed. Concealing the hinge may provide additional protection against an intruder attempting to break into the workstation 100.

The workstation 100 may also be locked in the closed position. To provide additional security features to the workstation, an internal lock 500 may be incorporated into an exterior surface 502 of at least one of the multi-fold doors 104, 106. Any appropriate lock may be used in accordance with the principles described in the present disclosure. For example, a striker/bolt lock may be incorporated into the tertiary compartment's exterior. When the striker/bolt is moved in the upward position, the striker/bolt may interlock with an opening formed in the top member 206 of the base workstation compartment 200. In other examples, such a striker/bolt type lock may be arranged to interlock with the floor 202 of the base workstation compartment 200. In other examples, the lock may be incorporated into the exterior of the secondary compartment 214.

With the striker/bolt lock interlocked with a portion of the base workstation compartment 200, the first of the two multi-fold doors 104 may be locked into place. The other multi-fold door 106 may then be closed. One advantage to the present arrangement is that the striker/bolt lock described above will also be concealed from outside of the workstation when the workstation is in the closed position. The last multi-fold door 106 to close may then be locked with a lock that is accessible to the outside of the workstation.

While the workstation above has been described with reference to specific locks, compartments, bins, hooks, perforated hardboards, and other features, any appropriate type of feature may be used in accordance with the principles described in the present disclosure. For example, more or less wheels may be used to support various compartments of the workstation. Likewise, more or less locks may be used to lock the entire workstation or just specific compartments of the workstation. Further, while the description of the workstation above makes reference varying heights of the different compartments, in other examples, all of the compartments have the same height or the tertiary and secondary compartments have the same height.

The preceding description has been presented only to illustrate and describe embodiments of the present scrapbook workstation. It is not intended to be exhaustive or to limit the invention to any precise form disclosed. Many modifications and variations are possible in light of the above teaching.

What is claimed is:

1. A compact workstation, comprising:
a base workstation compartment including a floor, a plurality of side walls, a top member, and a back member, each of the side walls being joined to the floor, the back member, and the top member forming a first cavity with a first depth;
at least one multi-fold door rotatably coupled to each of the side walls, wherein the at least one bimulti-fold door includes a secondary compartment and a tertiary compartment, wherein the secondary compartment is rotatably coupled on a first side to the side walls of the base workstation compartment, the secondary compartment comprising a second cavity with a second depth;
the tertiary compartment is rotatably coupled to a second side of the secondary compartment, the tertiary compartment forming a third cavity with a third depth;
a base underside of the base workstation compartment being supported by at least a first wheel and a second wheel;
the secondary compartment being supported by at least a third wheel and a fourth wheel; and
the tertiary compartment being supported by at least a fifth wheel and a sixth wheel.

2. The compact workstation of claim 1, wherein the multi-fold door is a bi-fold door.

3. The compact workstation of claim 1, wherein the second depth is less than the first depth, and the third depth is less than the second depth.

4. The compact workstation of claim 1, wherein the side walls of the base workstation compartment include an interior height that spans from the floor to the top member and the tertiary compartment each comprise an exterior height that is less than the interior height of the base workstation compartment.

5. The compact workstation of claim 4, wherein the exterior height of the tertiary compartment is greater than 90.0 percent of the interior height of the base workstation compartment.

6. The compact workstation of claim 4, wherein a vertical position of the tertiary compartment and the exterior height of the tertiary compartment allows the tertiary compartment to reside within the first cavity of the base workstation compartment when the secondary compartment and the tertiary compartment are in closed positions.

7. The compact workstation of claim 1, wherein the at least fifth and sixth wheels are disposed along a width of the tertiary compartment.

8. The compact workstation of claim 1, wherein the at least third and fourth wheels are positioned adjacent to hinges that connect the secondary compartment to the tertiary compartment.

9. The compact workstation of claim 1, further comprising at least a seventh wheel and an eighth wheel supporting the secondary compartment, wherein the seventh wheel and the eighth wheel are disposed along a width of the secondary compartment.

10. The compact workstation of claim 1, wherein the floor of the base workstation compartment defines a cutout that accommodates the at least fifth wheel and sixth wheel when the secondary compartment and the tertiary compartment are in a closed position.

11. The compact workstation of claim 1, wherein at least one of the multi-fold doors includes an exterior lock disposed adjacent an internal portion of the base workstation compartment when the at least one of the multi-fold doors is in a closed position.

12. The compact workstation of claim 1, further comprising a collapsible table rotatably coupled to the base workstation compartment.

13. The compact workstation of claim 1, wherein at least one of the base workstation compartment, the secondary compartment, and the tertiary compartment comprise shelving brackets to receive at least one shelf.

14. The compact workstation of claim 1, wherein at least one of the tertiary compartments comprise a perforated hardboard.

15. A compact workstation, comprising:
a base workstation compartment including a floor, a plurality of side walls, a top member, and a back member, each of the side walls being joined to the floor, the back member, and the top member forming a first cavity with a first depth;
at least one bi-fold door rotatably coupled to each of the side walls, wherein the at least one bi-fold door includes a secondary compartment and a tertiary compartment, wherein the secondary compartment is rotatably coupled on a first side to the side walls of the base workstation compartment, the secondary compartment comprising a second cavity with a second depth that is less than the first depth;
the tertiary compartment is rotatably coupled to a second side of the secondary compartment, the tertiary compartment forming a third compartment with a third depth that is less than the second depth;
a base underside of the base workstation compartment being supported by at least a first wheel and a second wheel;
the secondary compartment being supported by at least a third wheel and a fourth wheel where the at least fifth and sixth wheels are disposed along a width of the tertiary compartment;
the tertiary compartment being supported by at least a fifth wheel and a sixth wheel where the at least third and fourth wheels are positioned adjacent to hinges that connect the secondary compartment to the tertiary compartment; and
at least a seventh wheel and an eighth wheel supporting the secondary compartment, wherein the seventh wheel and the eighth wheel are disposed along a width of the secondary compartment.

16. The compact workstation of claim 15, wherein the side walls of the base workstation compartment include an interior height that spans from the floor to the top member and the tertiary compartment each comprise an exterior height that is less than the interior height of the base workstation compartment.

17. The compact workstation of claim 16, wherein the exterior height of the tertiary compartment is greater than 90.0 percent of the interior height of the base workstation compartment.

18. The compact workstation of claim 16, wherein a vertical position of the tertiary compartment and the exterior height of the tertiary compartment allows the tertiary compartment to reside within the first cavity of the base workstation compartment when the secondary compartment and the tertiary compartment are in closed positions.

19. The compact workstation of claim 15, wherein the floor of the base workstation compartment defines a cutout that accommodates the at least fifth wheel and sixth wheel when the secondary compartment and the tertiary compartment are in a closed position.

20. A compact workstation, comprising:
a base workstation compartment including a floor, a plurality of side walls, a top member, and a back member, each of the side walls being joined to the floor, the back member, and the top member forming a first cavity with a first depth;
at least one bi-fold door rotatably coupled to each of the side walls, wherein the at least one bi-fold door includes a secondary compartment and a tertiary compartment, wherein the secondary compartment is rotatably coupled on a first side to the side walls of the base workstation compartment, the secondary compartment comprising a second cavity with a second depth that is less than the first depth;
the tertiary compartment is rotatably coupled to a second side of the secondary compartment, the tertiary compartment forming a third compartment with a third depth that is less than the second depth;
the side walls of the base workstation compartment include an interior height that spans from the floor to the top member and the tertiary compartment each comprise an exterior height that is less than the interior height of the base workstation compartment;
the exterior height of the tertiary compartment is greater than 90.0 percent of the interior height of the base workstation compartment;
a vertical position of the tertiary compartment and the exterior height of the tertiary compartment allows the tertiary compartment to reside within the first cavity of the base workstation compartment when the secondary compartment and the tertiary compartment are in closed position;
a base underside of the base workstation compartment being supported by at least a first wheel and a second wheel;
the secondary compartment being supported by at least a third wheel and a fourth wheel where the at least fifth and sixth wheels are centered along a width of the tertiary compartment;
the tertiary compartment being supported by at least a fifth wheel and a sixth wheel where the at least third and fourth wheels are positioned adjacent to hinges that connect the secondary compartment to the tertiary compartment;
at least a seventh wheel and an eighth wheel supporting the secondary compartment, wherein the seventh wheel and the eighth wheel are centered along a width of the secondary compartment;
the floor of the base workstation compartment defines a cutout that accommodates the at least fifth wheel and sixth wheel when the secondary compartment and the tertiary compartment are in a closed position;
at least one of the secondary compartments includes an exterior lock that is arranged to lock into an internal portion of the base workstation compartment when the at least one secondary compartment is in the closed position;
a collapsible table rotatably coupled to the base workstation compartment, wherein the collapsible table is arranged to be rotated from the vertical position to a horizontal position;
at least one of the base workstation compartment, the secondary compartment, and the tertiary compartment comprise shelving brackets to receive at least one shelf; and
at least one of the tertiary compartments comprise a perforated hardboard.
